(19) United States
(12) Patent Application Publication
(10) Pub. No.: US 2013/0132081 A1
(43) Pub. Date: May 23, 2013

(54) CONTENTS PROVIDING SCHEME USING SPEECH INFORMATION

(71) Applicant: KT CORPORATION, Seongnam (KR)

(72) Inventors: Chang-Sun RYU, Seoul (KR); Myoungwan KOO, Seoul (KR); Hee-Kyung KIM, Seoul (KR); Sung-Chan PARK, Seoul (KR); Jae-Han PARK, Seoul (KR); Dong-Hoon AHN, Seoul (KR); Kyong-Nim LEE, Seoul (KR); Young-Ho HAN, Yongin-si (KR)

(73) Assignee: KT CORPORATION, Seongnam (KR)

(21) Appl. No.: 13/683,333

(22) Filed: Nov. 21, 2012

(30) Foreign Application Priority Data
Nov. 21, 2011 (KR) 10-2011-0121543

(51) Int. Cl. G10L 21/06

(52) U.S. Cl. CPC G10L 21/06
USPC 704/235

(57) ABSTRACT

An apparatus for providing contents based on speech information is provided. The apparatus includes a speech information reception unit configured to receive speech information from a first device, a device identification unit configured to receive device information of the first device from the first device and identify the first device based on the received device information, a speech information translation unit configured to translate the speech information into text information according to the received device information, and a contents provision unit configured to search for contents based on the translated text information, and provide the searched contents to a second device.

### CROSS-REFERENCE TO RELATED APPLICATION

This application claims priority from Korean Patent Application No. 10-2011-0121543, filed on Nov. 21, 2011 in the Korean Intellectual Property Office, the entire disclosure of which is incorporated herein by reference.

### FIELD

Apparatuses and methods consistent with exemplary embodiments relate to an apparatus and a method for searching contents using speech information.

### BACKGROUND

Internet Protocol Television (IPTV) is a system through which interactive television services are delivered using the Internet to provide information services, movies, and broadcasts.

Unlike an Internet TV, the IPTV uses a TV and a remote control instead of a computer monitor and a mouse, respectively. Therefore, even if a user is not used to a computer, he/she can easily search on the Internet by using a remote control and can be provided with various contents and optional services, such as movies, home shopping services, and games, provided by the Internet.

Further, unlike public broadcasting services, cable TV services, and satellite broadcasting services, the IPTV provides only programs a viewer wants to see at his/her convenient time. Such interactivity facilitates providing more various services.

In a conventional IPTV service, a user searches and controls contents by using a remote control. Recently, a method using a device such as a smartphone has been suggested.

However, contents to be provided are various and a smartphone is limited to a touch type input apparatus. Therefore, a user who is not used to a touch type device cannot easily use this method.

As one of prior art techniques concerning this, Korean Patent Laid-open Publication No. 2011-0027362 entitled “IPTV system and service using speech interface” describes a technique for providing requested contents to an IPTV by using a speech input from a user.

### SUMMARY

In order to address the above-described conventional problems, exemplary embodiments provide a contents provider apparatus and a method capable of searching for contents by using speech information provided from a device and also capable of providing the searched contents to another device.

The exemplary embodiments provide a contents provider apparatus and method capable of improving speech recognition performance of recognizing speech information provided from a plurality of devices.

According to an aspect of an exemplary embodiment, an apparatus for providing contents based on speech information is provided. The apparatus includes a receiver configured to receive speech information from a first device, a device identifier configured to receive device information of the first device from the first device and identify the first device based on the received device information, an information translator configured to translate the speech information into other information according to the received device information and a contents provider configured to search for contents based on the translated other information, and provide the contents to a second device.

The device identifier may be configured to identify a device type of the first device based on the received device information, and the information translator may be configured to translate the speech information into the other information according to the identified device type.

The information translator may comprise a plurality of speech recognition modules corresponding to each of a plurality of device types.

The device type of the first device may comprise at least one from among communication network information of the first device, platform information of the first device, software information of the first device, hardware information of the first device, manufacturer information of the first device, and model information of the first device.

The apparatus may further comprise: a control command generator configured to generate a control command capable of controlling the second device.

The control command generator may be configured to receive control information of the second device from the first device, generate the control command capable of controlling the second device based on the received control information, and send the generated control command to the second device.

The sound volume of the second device may be controlled in response to the control command.

The sound volume of the second device may be controlled to be turned down when speech is input to the first device from a user.

The speech information may be generated by the first device when speech is input to the first device from a user.

According to an aspect of another exemplary embodiment, a method for providing contents based on first information is provided. The method comprises receiving device information of a first device from the first device, receiving speech information from the first device, translating the speech information into other information according to the received device information, searching for contents based on the translated other information and providing the contents to a second device.

The translating the speech information into the other information may comprise: identifying a device type of the first device based on the received device information; and translating the speech information into the other information according to the identified device type.

The device type of the first device may comprise at least one from among communication network information of the first device, platform information of the first device, software information of the first device, hardware information of the first device, manufacturer information of the first device, and model information of the first device.

The method may further comprise:receiving control information of the second device from the first device; generating a control command capable of controlling the second device based on the received control information; and sending the generated control command to the second device.

The sound volume of the second device may be controlled in response to the control command.

According to an aspect of another exemplary embodiment, a method for sending, from a first device, speech information to an apparatus is provided. The method includes sending, to the apparatus, control information of a second device selected by a user, receiving speech from the user, generating the speech information corresponding to the received speech and sending the generated speech information to the apparatus, wherein the speech information sent to the apparatus is used when the apparatus searches for contents that are to be transmitted to the second device.

The control information sent to the apparatus may be used when the apparatus generates a control command that is to be transmitted to the second device.

The sound volume of the second device may be controlled to be turned down when the speech is input to the first device.

The other information may comprise text information.

In accordance with the exemplary embodiments, it is possible to search for contents by using speech information and also possible to provide the searched contents to any one of a plurality of devices.

In accordance with the exemplary embodiments, speech information is translated into other information considering characteristics of the respective devices, so that speech recognition performance can be improved.

### BRIEF DESCRIPTION OF THE DRAWINGS

Non-limiting and non-exhaustive exemplary embodiments will be described in conjunction with the accompanying drawings. Understanding that these drawings depict only several exemplary embodiments in accordance with the disclosure and are, therefore, not intended to limit its scope, the disclosure will be described with specificity and detail through use of the accompanying drawings, in which:

FIG. 1 is a diagram illustrating an entire system for providing contents based on speech information in accordance with an exemplary embodiment;

FIG. 2 is a detailed diagram illustrating a contents provider apparatus in accordance with an exemplary embodiment;

FIG. 3 is a detailed diagram illustrating a contents provider apparatus in accordance with another exemplary embodiment;

FIGS. 4A-4D are diagrams illustrating examples of a contents providing service provided by a contents provider apparatus;

FIG. 5 is a flowchart for describing a method for providing contents based on speech information in accordance with another exemplary embodiment.

### DETAILED DESCRIPTION

Hereinafter, exemplary embodiments will be described in detail with reference to the accompanying drawings so that the exemplary embodiments may be readily implemented by those skilled in the art. However, it is to be noted that the present disclosure is not limited to the exemplary embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

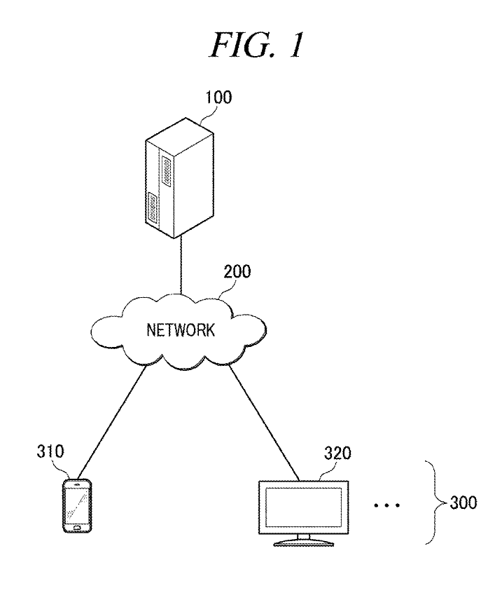

FIG. 1 is a diagram illustrating an entire system for providing contents based on speech information in accordance with an exemplary embodiment.

A contents provider apparatus 100 is connected to a user device via a network 200.

The network 200 may be a wired network such as a local area network (LAN), a wide area network (WAN), a value added network (VAN) or one of all kinds of wireless networks such as a mobile radio communication network and a satellite communication network.

The user device 300 may be a computer or a hand-held device which can be connected to a remote apparatus via the network 200. Herein, the computer is, for example, a notebook computer, a desktop computer, and a laptop computer which are equipped with a web browser, and the hand-held device is a wireless communication device with guaranteed portability and mobility and may be, for example, one of all kinds of hand-held based wireless communication devices such as Personal Communication System (PCS), Global System for Mobile communications GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (Wibro) device, and a smartphone.

The user device 300 may be a TV device or a remote controller corresponding to the TV device. By way of example, a first device may be a remote controller corresponding to a TV device and a second device may be the TV device. In this case, the remote controller may be a device, such as a microphone, capable of inputting speech information.

When the contents provider apparatus 100 receives speech information from, for example, a first device 310 as a type of user device 300, the contents provider apparatus 100 translates the speech information into text information based on device information of the first device 310. Based on the translated text information, the contents provider apparatus 100 searches for contents and provides the searched contents to a device, for example, a second device 320, selected by the first device 310.

Herein, the second device 320 is configured to output the contents searched based on the speech information and is selected from a plurality of devices by the first device 310. The second device 320 may be selected by the first device 310.

A user may select an icon corresponding to the second device 320 by using a user interface of the first device 310 or an application installed in the second device 320. The first device 310 transmits control information related to the second device 320 to the contents provider apparatus 100.

The contents provider apparatus 100 generates a control command for the second device 320 based on the control information of the second device 320 received from the first device 310. In this case, the contents provider apparatus 100 may receive control information of the second device from the first device, generate the control command capable of controlling the second device based on the received control information, and send the generated control command to the second device.

When the contents provider apparatus 100 transmits the generated control command to the second device 320, the second device 320 is controlled in response to the received control command In this case, sound volume of the second device 320, for example, can be controlled to be turned down in response to the control command

When speech is input from the user, the first device 310 generates speech information. By way of example, when the user records speech by using an input device such as a microphone, the first device 310 generates speech information.

In this case, while the speech information is generated by the first device 310, the second device 320 controls the sound volume of the second device in response to the control command so as not to expose the speech information to static.

That is, while recording speech through the first device 310, the user turns down the sound volume of the second device 320, so that it is possible to prevent the second device 320 from generating static.

By way of example, if the user selects the second device 320 by the first device 310 and touches a speech input icon to input speech, the contents provider apparatus 100 receives control information of the second device 320 from the first device 310, generates a control command, and transmits the generated control command to the second device 320. While the sound volume of the second device 320 is turned down, the first device records speech and generates speech information.

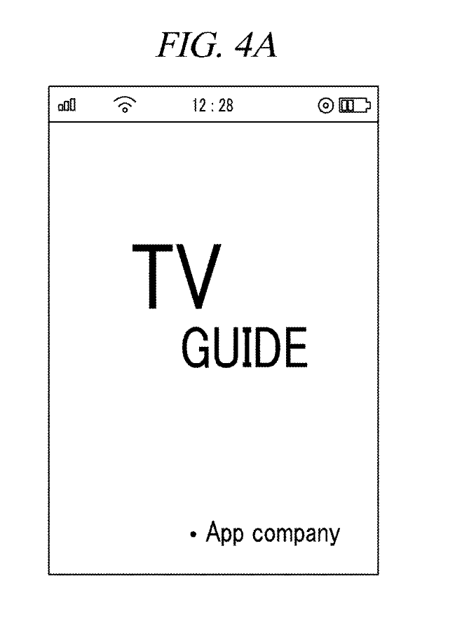

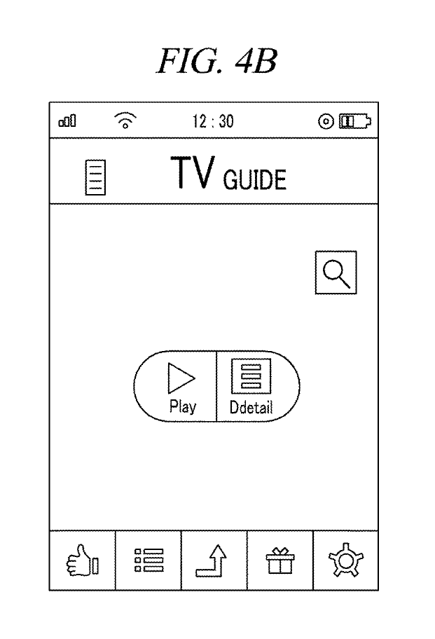

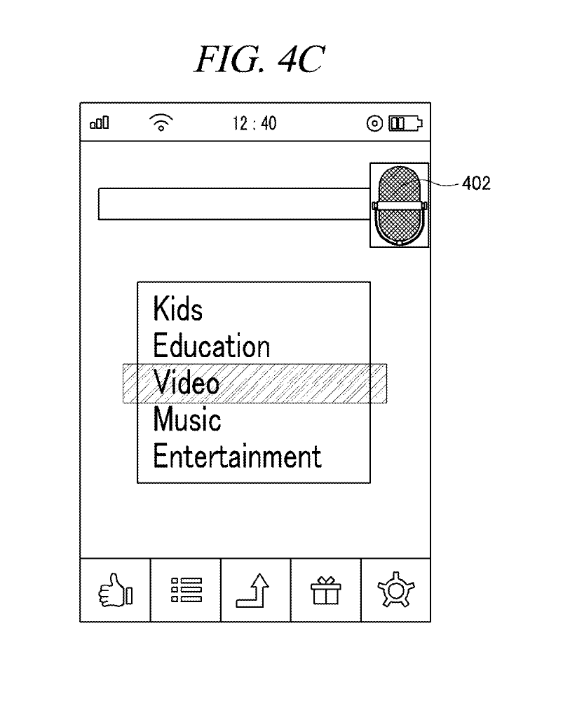

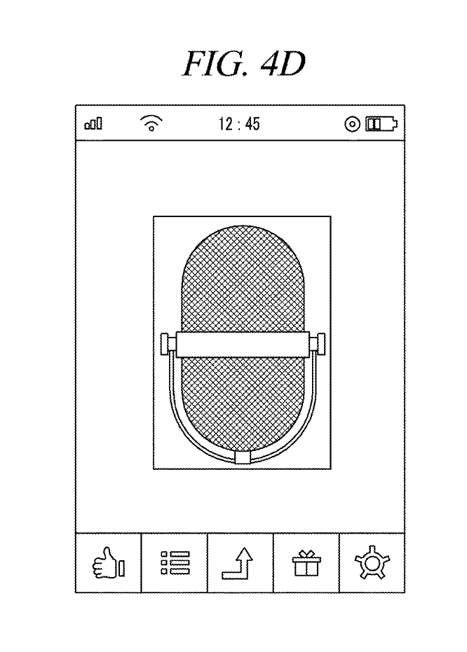

This will be explained later with reference to FIG. 4.

The first device 310 transmits the generated speech information to the contents provider apparatus 100. Together with the speech information, the first device 310 transmits the device information of the first device 310.

The contents provider apparatus 100 identifies a device type of the first device 310 based on the device information of the first device 310 received from the first device 310. Based on the identified device type of the first device 310, the contents provider apparatus 100 translates the speech information into text information.

Further, the contents provider apparatus 100 searches for contents based on the translated text information and provides content information searched to the second device 320.

The second device 320 outputs contents corresponding to the provided content information. The second device 320, for example, reproduces a video corresponding to the provided content information.

Therefore, the user can conveniently select a device from among a multiple number of devices for reproducing contents by using another device of the multiple number of devices and easily search contents the user wants to see by speech. The speech information capable of controlling the second device to be turned down is generated by the first device when speech is input to the first device from a user so that a noise effect caused from the second device can be decreased. Accordingly, it is possible to improve speech recognition performance.

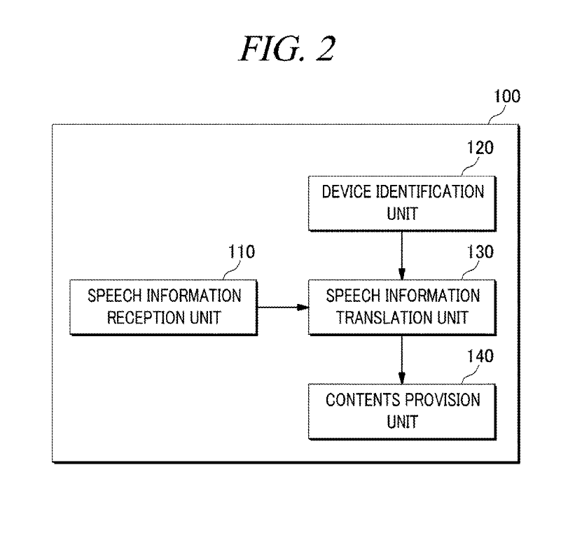

FIG. 2 is a detailed diagram illustrating a contents provider apparatus in accordance with an exemplary embodiment.

Referring to FIG. 2, the contents provider apparatus 100 includes a speech information reception unit 110, a device identification unit 120, a speech information translation unit 130, and a contents provision unit 140.

The speech information reception unit 110 receives speech information from a first device (illustration omitted). Herein, the speech information can be generated when speech is recorded by the first device from the user.

The device identification unit 120 receives device information of the first device from the first device and identifies a device type of the first device based on the received device information of the first device. Herein, the device type of the first device may include at least one of information of a communication network to which the first device belongs, platform information of the first device, information of software installed in the first device, hardware information of the first device, manufacturer information of the first device, and model information of the first device.

Further, the device identification unit 120 classifies and stores device types of the respective devices including the first device in advance. The device identification unit 120 can identify a device type of the first device corresponding to the device information of the first device.

The speech information translation unit 130 translates the speech information into text information based on the device information of the first device. The speech information translation unit 130 can translate the speech information into text information based on the device type of the first device identified by the device identification unit 120.

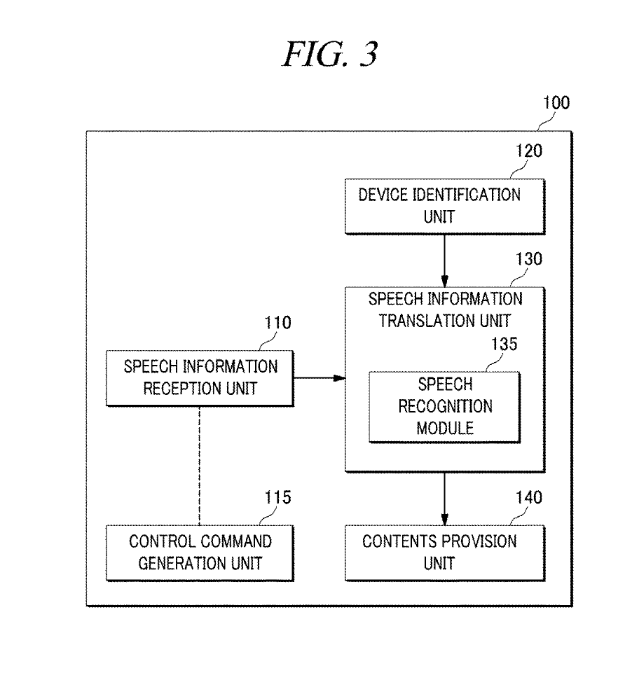

The speech information translation unit 130 may further include a speech recognition module (illustration omitted) that translates the speech information into text information based on the device type of the first device. This will be explained later with reference to FIG. 3.

The contents provision unit 140 searches contents based on the translated text information and provides content information searched to a second device. In this case, the contents provision unit 140 may include a search engine for searching contents corresponding to the text information. Further, the contents provision unit 140 may request a content search from a separate search apparatus that searches contents and may be provided with content information searched.

The second device may play contents corresponding to the provided content information.

FIG. 3 is a detailed diagram illustrating a contents provider apparatus in accordance with another exemplary embodiment.

Referring to FIG. 3, the contents provider apparatus 100 includes the speech information reception unit 110, a control command generation unit 115, the device identification unit 120, the speech information translation unit 130, a speech recognition module 135, and the contents provision unit 140

The speech information reception unit 110 receives speech information from a first device (illustration omitted). Herein, the speech information can be generated when speech is recorded by the first device from the user.

The control command generation unit 115 generates a control command for a second device (illustration omitted). Herein, the second device is selected by the first device and is provided with content information searched by using the speech information received from the first device.

That is, the control command generation unit 115 receives control information for the second device from the first device, generates a control command based on the received control information, and transmits the generated control command to the second device. In this case, sound volume of the second device is controlled in response to the control command transmitted to the second device.

By way of example, if control information of the second device is transmitted to the control command generation unit 115 before the first device generates speech information, the control command generation unit 115 generates a control command based on the received control information and transmits the generated control command to the second device. The second device controls sound volume of the second device in response to the received control command Therefore, while speech information is generated by the first device, the control command generation unit 115 controls the sound volume of the second device to be turned down and prevents static from being mixed into the speech information.

The device identification unit 120 receives device information of the first device from the first device and identifies a device type of the first device based on the received device information of the first device. Herein, the device type of the first device may include at least one of information of a communication network to which the first device belongs, platform information of the first device, information of software installed in the first device, hardware information of the first device, manufacturer information of the first device, and model information of the first device.

Further, the device identification unit 120 classifies and stores device types of the respective devices including the first device in advance. The device identification unit 120 can identify a device type of the first device corresponding to the device information of the first device.

The speech information translation unit 130 translates the speech information into text information based on the device information of the first device.

The speech information translation unit 130 includes the speech recognition module 135 that translates the speech information into text information based on the device type of the first device.

To be specific, the speech information translation unit 130 includes a plurality of speech recognition modules 135 each corresponding to each of a plurality of device types, including the device type of the first device. A device type is classified depending on a kind of a device and characteristics of speech are varied depending on a device type classified by a manufacturer, a model, and hardware of a device. Therefore, the speech recognition module 135 corresponding to each device type recognizes speech, so that a speech recognition function can be improved. Accordingly, it becomes easy for the contents provider apparatus 100 to search contents by speech information.

Among the plurality of speech recognition modules 135, any one speech recognition module 135 corresponding to the device type of the first device recognizes speech information and the speech information translation unit 130 translates the recognized speech information into text information.

The contents provision unit 140 searches contents based on the translated text information and provides content information searched to a second device.

Therefore, a user can search contents by speech information generated in a device and also provide the contents to another device.

While speech information is generated in a device, the contents provider apparatus 100 controls another device, so that it is possible to minimize static. Further, the contents provider apparatus 100 improves a function of recognizing speech corresponding to speech information depending on a device type. Therefore, it becomes easy for the contents provider apparatus 100 to search contents by speech information.

FIGS. 4A-4D illustrate examples in which contents are searched using speech information.

By way of example, as depicted in FIG. 4A, if a first device is a smartphone, a user may start an application for using a content search service in the smartphone. The user selects a second device, for example, an IPTV, to be provided with contents.

As depicted in FIG. 4B, the user may click on a search icon 401 to search contents. As depicted in FIG. 4C, the user clicks on a microphone icon 402 in a search window to input speech information. At this time, when the user clicks on the microphone icon 402, control information of the second device may be transmitted to a contents provider apparatus. Then, the contents provider apparatus generates a control command based on the control information and transmits the control command to the second device, so that sound volume of the second device can be controlled.

As depicted in FIG. 4D, the user records speech in the first device through an input device such as a microphone, and speech information is generated and transmitted to the contents provider apparatus. The contents provider apparatus translates the received speech information into text information based on a device type of the first device and searches contents corresponding to the translated text information.

Content information searched by the contents provider apparatus may be output in a list format by the first device. The searched content information may be output directly by the second device.

When the user selects any one contents from the list output by the first device and touches a view icon, the selected contents is output by the second device.

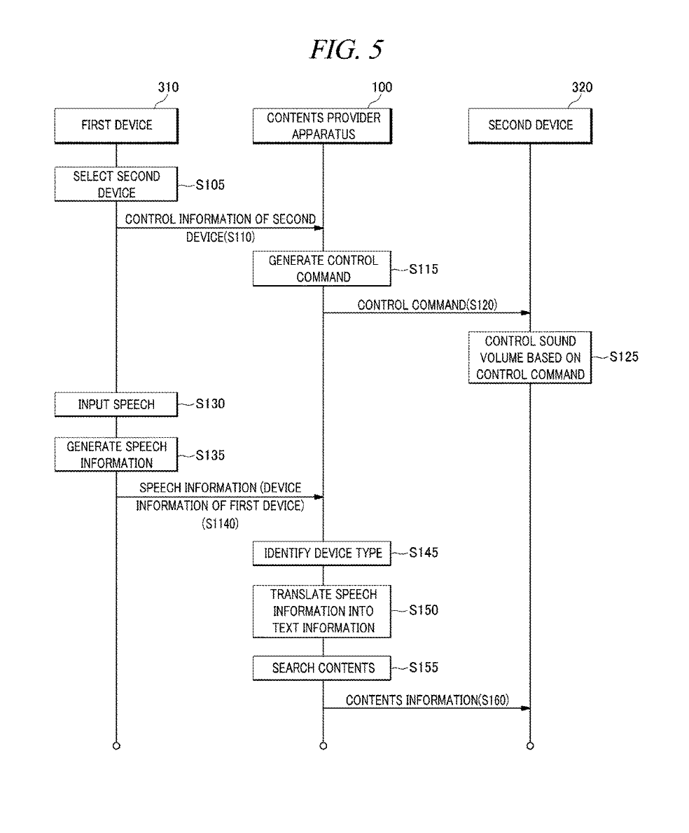

FIG. 5 is a flowchart for describing a method for providing contents based on speech information in accordance with another exemplary embodiment.

Referring to FIG. 5, the first device 310 of the user selects the second device 320 (operation S105). Herein, the second device 320 is configured to output contents searched based on speech information and is selected by the first device 310 from a plurality of devices.

The first device 310 transmits control information of the second device 320 to the contents provider apparatus 100 (operation S110).

The contents provider apparatus 100 generates a control command capable of controlling the second device 320 based on the control information of the second device 320 received from the first device 310 (operation S115) and transmits the generated control command to the second device 320 (operation S120).

The second device 320 controls sound volume of the second device 320 to be turned down in response to the received control command (operation S125). The sound volume of the second device 320 may be turned down in response to the control command so that noise by the second device 320 is reduced.

The first device 310 receives speech from the user (operation S130). At this time, the first device 310 may receive speech from the user through an input device such as a microphone of the first device 310.

The first device 310 generates speech information based on the received speech (operation S135) and transmits the generated speech information to the contents provider apparatus 100 (operation S140). At this time, together with the speech information, the first device 310 transmits device information of the first device 310.

The contents provider apparatus 100 identifies a device type of the first device 310 based on the device information of the first device 310 received from the first device 310 (operation S145).

The contents provider apparatus 100 translates the speech information into text information based on the identified device type of the first device 310 (operation S150). Herein, the device type of the first device may include at least one of information of a communication network to which the first device belongs, platform information of the first device, information of software installed in the first device, hardware information of the first device, manufacturer information of the first device, and model information of the first device.

The contents provider apparatus 100 searches contents based on the translated text information (operation S155) and provides content information searched to the second device 320 (operation S160).

The contents provider apparatus 100 may include a search engine for searching contents corresponding to text information. Further, the contents provider apparatus 100 may request a content search from a separate search apparatus that searches contents and may be provided with content information searched.

The exemplary embodiments may be embodied in a transitory or non- transitory storage medium which includes instruction codes which are executable by a computer or processor, such as a program module which is executable by the computer or processor. A data structure in accordance with the exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of the exemplary embodiments is provided for the purpose of illustration, and it will be understood by those skilled in the art that various changes and modifications may be made without changing a technical conception and/or any essential features of the exemplary embodiments. Thus, the above-described exemplary embodiments are illustrative in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of the exemplary embodiments. It shall be understood that all modifications and embodiments conceived from the meaning and scope of the claims and their equivalents are included in the scope of the present inventive concept.

What is claimed is:

1. An apparatus for providing contents based on speech information, the apparatus comprising:
a receiver configured to receive the speech information from a first device;
a device identifier configured to receive device information of the first device from the first device and identify the first device based on the received device information;
an information translator configured to translate the speech information into other information according to the received device information; and
a contents provider configured to search for contents based on the translated other information, and provide the contents to a second device.

2. The apparatus of claim 1,
wherein the device identifier is configured to identify a device type of the first device based on the received device information, and
the information translator is configured to translate the speech information into the other information according to the identified device type.

3. The apparatus of claim 1,
wherein the information translator comprises a plurality of speech recognition modules corresponding to each of a plurality of device types.

4. The apparatus of claims 2,
wherein the device type of the first device comprises at least one from among communication network information of the first device, platform information of the first device, software information of the first device, hardware information of the first device, manufacturer information of the first device, and model information of the first device.

5. The apparatus of claim 1, further comprising:
a control command generator configured to generate a control command capable of controlling the second device.

6. The apparatus of claim 5,
wherein the control command generator is configured to receive control information of the second device from the first device, generate the control command capable of controlling the second device based on the received control information, and send the generated control command to the second device.

7. The apparatus of claim 6,
wherein sound volume of the second device is controlled in response to the control command.

8. The apparatus of claim 7,
wherein the sound volume of the second device is controlled to be turned down when speech is input to the first device from a user.

9. The apparatus of claim 1,
wherein the speech information is generated by the first device when speech is input to the first device from a user.

10. A method for providing contents based on speech information, the method comprising:
receiving device information of a first device from the first device;
receiving the speech information from the first device;
translating the speech information into other information according to the received device information;
searching for contents based on the translated other information; and
providing the contents to a second device.

11. The method of claim 10,
wherein the translating the speech information into the other information comprises:
identifying a device type of the first device based on the received device information; and
translating the speech information into the other information according to the identified device type.

12. The method of claim 11,
wherein the device type of the first device comprises at least one from among communication network information of the first device, platform information of the first device, software information of the first device, hardware information of the first device, manufacturer information of the first device, and model information of the first device.

13. The method of claim 10, further comprising:
receiving control information of the second device from the first device;
generating a control command capable of controlling the second device based on the received control information; and
sending the generated control command to the second device.

14. The method of claim 13,
wherein sound volume of the second device is controlled in response to the control command.

15. A method for sending, from a first device, speech information to an apparatus, the method comprising;
sending, to the apparatus, control information of a second device selected by a user;
receiving speech from the user;
generating speech information corresponding to the received speech; and
sending the generated speech information to the apparatus,
wherein the speech information sent to the apparatus is used when the apparatus searches for contents that are to be transmitted to the second device.

16. The method of claim 15, wherein the control information sent to the apparatus is used when the apparatus generates a control command that is to be transmitted to the second device.

17. The method of claim 16, wherein sound volume of the second device is controlled to be turned down when the speech is input to the first device.

18. The apparatus of claim 1, wherein the other information comprises text information.

19. The method of claim 11, wherein the other information comprises text information.

20. The method of claim 15, wherein the other information comprises text information.
